(19) United States
(12) Patent Application Publication
(10) Pub. No.: US 2008/0157565 A1
(43) Pub. Date: Jul. 3, 2008

(54) Vehicle Cab Suspension

(76) Inventor: Nikesh Bakshi, Granger, IN (US)

Correspondence Address: QUARLES & BRADY LLP, 411 E. WISCONSIN AVENUE, SUITE 2040, MILWAUKEE, WI, 53202-4497, US

(21) Appl. No.: 11/913,830

(22) PCT Filed: May 9, 2006
(86) PCT No.: PCT/US06/17910

§ 371 Date: Nov. 7, 2007

Related U.S. Application Data
(60) Provisional application No. 60/679,426, filed on May 10, 2005.

(51) Int. Cl. B62D 24/04

(52) U.S. Cl. 296/190.07

(57) ABSTRACT

A vehicle cab is pivoted to the chassis at the front and supported at the rear by a cab suspension unit that includes a laminate of interleaved elastomer and rigid plate layers. The laminate flexes in reaction to forces that act in the planes of the layers and is relatively resistant to forces that act normal to the layers such that it elastically absorbs shocks and vibrations from road irregularities and pitch and roll maneuvers and more stiffly resists acceleration and deceleration forces between the cab and the chassis.

### CROSS-REFERENCE TO RELATED APPLICATION

This claims the benefit of U.S. Provisional Patent Application No. 60/679,426 filed May 10, 2005.

### STATEMENT CONCERNING FEDERALLY SPONSORED RESEARCH OR DEVELOPMENT

Not applicable.

### FIELD OF THE INVENTION

This invention relates to a suspension for the cab of a vehicle of the type in which the cab is pivoted at the front of the cab to the chassis and has one or more vibration and shock dampening devices between the rear of the cab and the vehicle chassis, and in particular to an elastomeric device for such applications.

### BACKGROUND OF THE INVENTION

“Cab over” vehicles are well known, in which the truck cab is provided over the engine of the vehicle. In such vehicle constructions, the cab is typically pivoted to the chassis of the vehicle at the front of the cab, about a horizontal axis that runs laterally (perpendicular to the direction of normal straight line vehicle travel). The rear of the truck cab is typically supported with springs or air springs and shock absorbers between the rear of the truck cab and the vehicle chassis. As the cab pivots about the front axis, the rear of the cab bounces generally up and down. The springs and shock absorbers dampen the vibration and shocks which may otherwise be experienced by the driver as the cab pivots.

Such springs, and air springs in particular, and shock absorbers for this application, have required maintenance and been prone to failure as the suspension loads, both in compression and in tension, can be significant. In particular, in many cab suspensions, the cab is hinged to the frame with two bushings in the front, one near each front corner. One or more of the air spring/shock units mount the rear of the cab to the chassis. These units have usually been provided either one in the middle or on a side, or one on each side of the rear of the cab. Such suspensions, particularly the three-point suspensions, can encounter a problem due to twist loading. This happens, for example, when the truck backs up to engage its fifth wheel trailer hitch with a semi-trailer. In such situations a large shock load can be applied that tends to twist the cab about a longitudinal axis. In the absence of anything firmly affixing one side of the cab, the cab rotates around its front axis and hits the suspension. This can place a significant load on the air springs and shocks, both in compression and in tension loading, when the suspension rebounds.

In addition, the springs and shocks used previously required other structure around them to counter the acceleration and deceleration forces (fore and aft) that the vehicle cab is subjected to and to control lateral movement for pitch and roll movements of the cab when cornering.

### SUMMARY OF THE INVENTION

The invention provides a vehicle cab suspension unit that supports the rear of a vehicle cab that is hinged at the front to a chassis of the vehicle to pivot relative to the chassis about an axis that is perpendicular to the direction of forward straight vehicle travel (the longitudinal axis of the vehicle). The suspension unit includes an elastomer and metal laminate in which metal layers are interleaved with elastomer layers, the elastomer layers being fixed to the metal layers at interfaces between the elastomer and metal layers such that sheer forces can be transmitted generally parallel to the layers from one layer to the next. The laminate is oriented between the chassis and the cab with the layers subjected to sheer forces when the cab pivots about the axis relative to the chassis.

Although the layers need not be oriented in vertical planes, in the disclosed embodiment they are. Were it desired to change the stiffness of the suspension unit or its natural frequency, the unit could be oriented so that the layers were in planes at an angle to vertical. The load carrying capacity of the suspension unit would also be increased by so increasing the angle to vertical.

Also, when the layers are oriented in vertical planes, the layers are subjected to compression from end to end (in the thickness direction of the layers) when the vehicle is stopped due to deceleration forces on the cab, and tension when the vehicle accelerates due to acceleration forces on the cab, which is desirable. The unit can also be arranged so that the layers are subjected to tension upon deceleration or compression upon acceleration, although since deceleration forces tend to be greater than acceleration forces, the former is preferable. The stiffness of the unit in compression and tension along the direction of the thickness of the layers is greater than the stiffness in sheer and therefore the unit is well adapted to counter the acceleration and deceleration forces of the vehicle. In addition, the characteristics of the unit in reaction to acceleration and deceleration forces can be adjusted by changing the angle of the layers to vertical, as described above, reducing its stiffness to acceleration and deceleration forces by increasing the angle between the planes of the layers and a vertical plane.

In addition, in another feature of the invention, the stiffness of the unit can be varied by varying the thicknesses of the layers. Thicker elastomer layers combined with thinner metal layers, within the same size envelope of the unit, result in a more flexible unit, whereas thinner elastomer layers combined with thicker metal plates results in a stiffer unit. Also, the hardness of the elastomer can be varied to also vary the stiffness.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a portion of a vehicle incorporating a suspension unit of the invention;

FIG. 2 is a rear perspective view of the vehicle of FIG. 1 in which the unit is visible;

FIG. 3 is a left side plan view of the vehicle of FIGS. 1 and 2;

FIG. 4 is a top perspective view illustrating the area of the vehicle in which the suspension unit is mounted;

FIG. 5 is a perspective view of the unit mounted to the vehicle; and

FIG. 6 is a perspective view of the elastomer and metal plate laminate which is included in the suspension unit.

### DETAILED DESCRIPTION OF THE PREFERRED EMBODIMENT

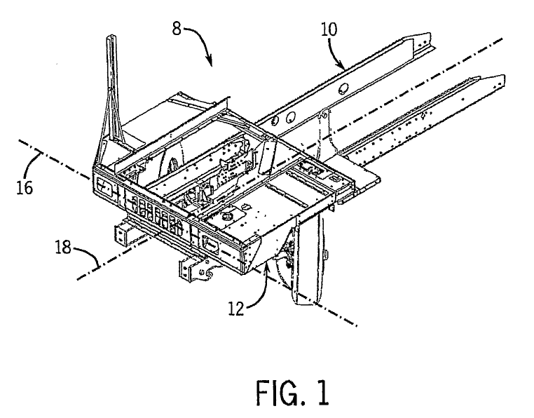

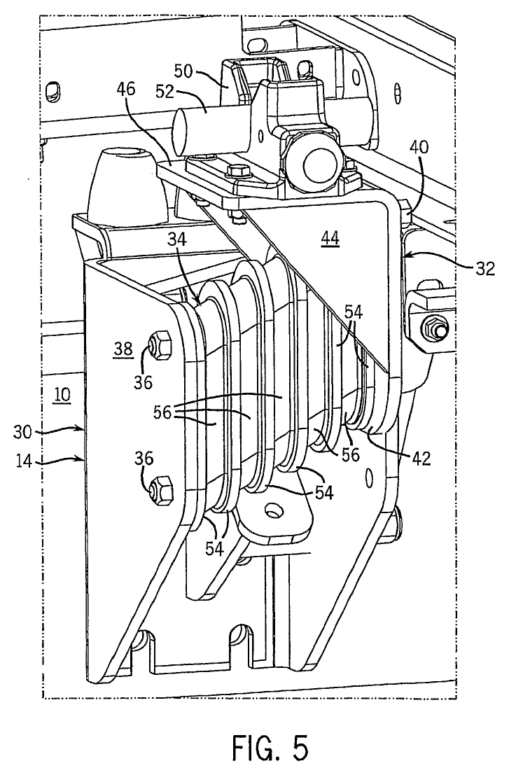

FIGS. 1-5 illustrate a vehicle 8 including a cab 12 (only the lower portion of which is shown), a chassis 10 and a suspension unit 14 of the invention. The cab 12 is pivotally mounted to the chassis 10 so as to rotate about axis 16 or an axis parallel to axis 16 by any suitable means, which may be conventional. Near the front of the cab 12, the axis 16 runs laterally, being generally horizontal and perpendicular to the direction 18 of normal forward straightline travel of the vehicle 8. The vehicle 8 has ground engaging front wheels 20 (the rear wheels not being shown) that support a beam 22 from which the primary suspension of the vehicle is mounted, the primary suspension including leaf springs 24 and shock absorbers 26 that extend between the beam 22 and the chassis 10. The suspension unit 14 provides a secondary suspension for the cab between the cab 12 and the chassis 10.

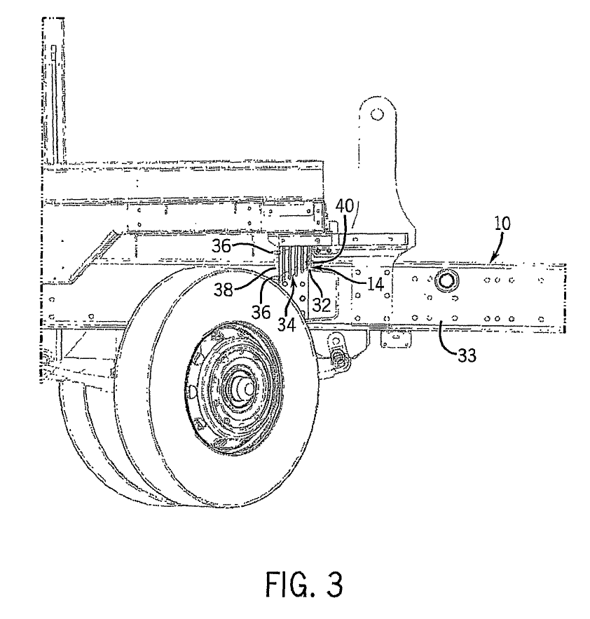

Referring primarily to FIGS. 3-5, the suspension unit 14 includes two brackets 30 and 32 and an elastomer laminate 34. The bracket 30 is bolted or otherwise affixed to the driver side rail 33 of the chassis 10 so that it is fixed relative to the chassis. The chassis end of the laminate 34 is fastened by fasteners 36 to a plate 38 of the bracket 30 that has the surface against which the laminate 34 is bolted extending in a plane that is lateral to the direction of motion of the vehicle 18. The opposite end of the laminate 34 is bolted by bolts 40 to a plate 42 of the bracket 32 that has the surface against which the laminate 34 is bolted also extending in a plane which is perpendicular to the direction of forward motion 18, and spaced rearwardly from the plate 38. As illustrated, the two plates 38 and 42 are parallel to one another and both perpendicular to the direction 18 of forward straight motion. The bracket 32 is a right angle bracket with a gusset 44 between the vertical plate 42 and the horizontal plate 46. The bracket 32 is supported by the laminate 34 from the bracket 30 and therefore from the chassis 10.

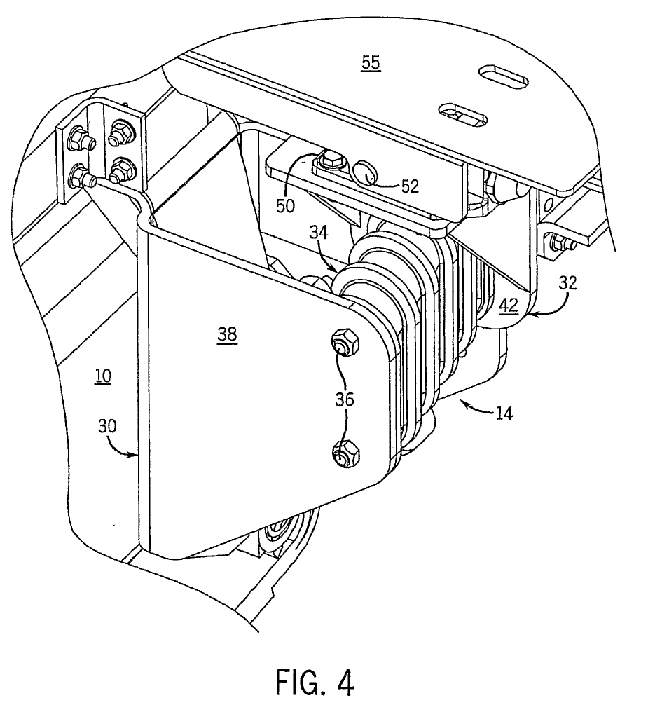

Mounted to the flange 46 is a locking unit 50, which may be conventional, (fasteners not shown but would be bolted to flange 46) that locks pin 52 that is fixed to bracket 55 (FIG. 4), and bracket 55 is bolted to the cab 12. The locking unit 50 is releasable to release pin 52 so that the cab 12 can be pivoted up about axis 16 from the position shown in FIG. 1.

The laminate 34 is made of metal, typically steel, plates 54 which are vulcanized or otherwise bonded or securely affixed to elastomer layers 56 of the unit 34. The interfaces between the elastomer layers 56 and the plates 54 may be flat or may have surface features that provide a mechanical connection. There is a plate 54 at each end of the laminate 34 into which the holes for the respective fasteners 36 and 40 are drilled and tapped, and so the end plates serve as the method by which to secure the laminate 34 to the chassis bracket 30 and to the floating bracket 32, the floating bracket securing the cab 12.

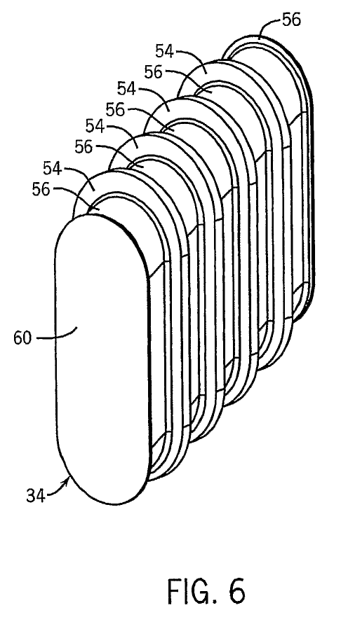

FIG. 6 illustrates the portion of the laminate 34 not including the end plates 54. FIG. 6 illustrates the interface surface 60 of the elastomer layer 56 on the bracket 30 end of the laminate 34 to be flat, and the facing interface surface of the end plate 54 would be similarly flat, the plates 54 and interleaved elastomer layers 56 being fixed together in a mold in which the elastomer layers 56 are cast and molded or vulcanized to the interleaved plates 54. The elastomer laminate 34 disclosed is commercially available from Cooper Standard of Novi, Mich. as part of the E-Z Cruise System.

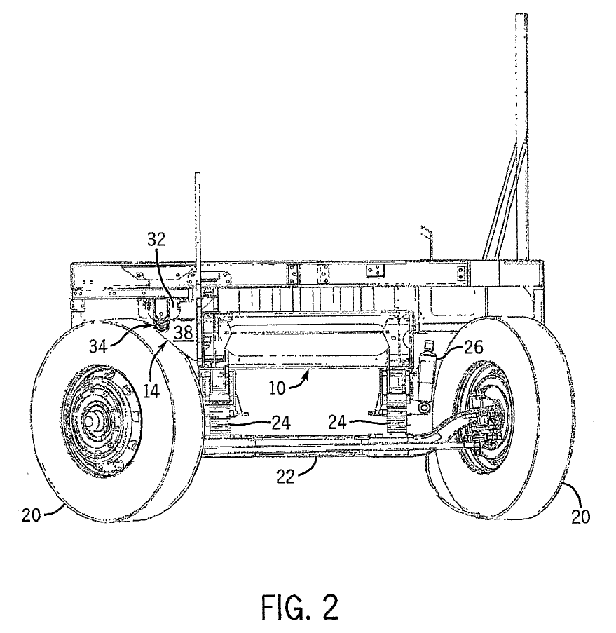

In the application of the elastomer laminate 34 to a vehicle cab suspension, the laminate may be oriented with its layers vertical, as illustrated in FIGS. 2-5, or the layers may be oriented at an angle, for example, so as to lie in a plane that is angled forwardly from vertical. Such an angled plane would still, preferably, be perpendicular to the direction 18 in the horizontal direction, in other words when viewed in a top view. This would make the effective stiffness of the laminate 34 greater since a vertical load applied between the two brackets 30 and 32 would result in a force component normal to the plane of the layers of the laminate 34, tending to compress or extend the layers in their thickness direction. In this direction, the elastomer layers are quite stiff, as are the metal layers, of course. However, in directions that lie in the planes of the layers, i.e., in the sheer directions—the plane of the height and width, the elastomer layers are relatively flexible, not only vertically, but also laterally (side to side). While angling the laminate 34 makes it stiffer to vertical movements between the cab and chassis, such angling makes the laminate 34 more flexible to acceleration and deceleration forces which are exerted between the chassis 10 and the cab 12. These are generally forces in the direction of line 18 and either tend to compress the layers of the laminate 34 or pull them apart, i.e., subject them to tension in the thickness direction. Angling the layers as described above would break these acceleration and deceleration forces into components, relative to the laminate, with one component acting to compress the layers and the other component acting in sheer on the layers, resulting in less resistance of the laminate 34 to counteract forces so directed.

Another way that the laminate 34 may be loaded is during cornering maneuvers of the vehicle when the cab tends to pitch and roll relative to the chassis. These forces are mainly in the planes of the laminate layers when the laminate is oriented vertically as illustrated in FIGS. 2-6, and therefore, the laminate is relatively flexible and able to conform to these forces while suspending the cab and absorbing and dampening harshness which may otherwise be present in these forces.

Only one suspension unit 14 is illustrated because in the vehicle illustrated, the cab is provided only on one side of the vehicle, this being in a yard truck-type application. For other types of vehicles where the cab extends across the full width of the vehicle, such as in over-the-road trucks, two or more of these suspension units 14 may be provided, for example, one on each side, or one on each side and one in the middle, or only one in the middle.

The stiffness of the laminate 34 can also be varied by varying the relative thicknesses of the elastomer layers 56 and the plate layers 54. This can be done within the dimensional envelope of the laminate 34, i.e., maintaining the same spacing from one end of the laminate 34 to the other. By making the elastomer layers thinner and the plate layers thicker, the stiffness is increased, and by making the elastomer layers 56 thicker and the plate layers 54 thinner, the stiffness is decreased. In addition, the stiffness can be varied by varying the hardness of the elastomer layers 56.

It is also noted that from one end to the other, i.e., from the forward end to the rearward end, the laminate 34 extends upwardly. This is desirable to give clearance at the top of the laminate 34 for downward movements of the rear end of the laminate 34 without the underside of the cab hitting on the top ends of the plates 54. In a different configuration, this may not be necessary, and the layers of the laminate 34 could be made aligned along a straight horizontal line with one another rather than angling up.

A preferred embodiment of the invention has been described in considerable detail. Many modifications and variations to the preferred embodiment described will be apparent to a person of ordinary skill in the art. Therefore, the invention should not be limited to the embodiments described, but should be defined by the claims that follow.

I claim:

1. In a vehicle cab suspension in which a vehicle cab is hinged at the front of the cab to a chassis of the vehicle to pivot relative to the chassis about an axis that is perpendicular to a direction of forward straight vehicle travel and at least one suspension unit supports the rear of the cab from the chassis, the improvement wherein the suspension unit comprises an elastomer rigid plate laminate in which rigid plate layers are interleaved with elastomer layers, the elastomer layers being fixed to the rigid plate layers at interfaces between the elastomer and rigid plate layers, and wherein the laminate is oriented between the chassis and the cab with the layers subjected to sheer forces when the cab pivots about the axis relative to the chassis.

2. The improvement of claim 1, wherein the laminate is oriented such that the layers are subjected to tension and compression in the fore and aft direction relative to the vehicle.

3. The improvement of claim 1, wherein the laminate is oriented such that the layers lie in planes that are perpendicular to the direction of forward straight vehicle travel.
